(19) United States
(12) Patent Application Publication
(10) Pub. No.: US 2005/0255772 A1
(43) Pub. Date: Nov. 17, 2005

(54) Composite fabric/silicone structure

(76) Inventor: Duncan C. Fung, Richmond, VA (US)

Correspondence Address: AUZVILLE JACKSON, JR., 8652 RIO GRANDE ROAD, RICHMOND, VA, 23229, US

(21) Appl. No.: 10/847,120

(22) Filed: May 17, 2004

(51) Int. Cl. B32B 27/12; B32B 25/02

(52) U.S. Cl. 442/168; 442/59; 442/169; 428/295.1; 428/295.4; 428/297.4; 428/298.1

(57) ABSTRACT

A composite structure comprising a fabric layer encapsulated in a silicone polymer or silicone rubber matrix. The fabric layer preferably comprises a woven fabric that includes apertures through which silicone polymer may penetrate during fabrication to provide complete or virtually complete encapsulation thereof in the silicone matrix Because of the method of fabrication, the fabric layer resides closer to one surface of the composite structure so that its esthetic design can be seen from at least one surface of the composite structure. Relatively heat resistant fabrics such as cotton and Nomex® are specifically preferred as the fabric portion, however, Teflon® coated fibers of other woven materials may also provide preferred structures. The incorporation of a thermally insulating ceramic into the silicone matrix further enhances the thermal insulating properties of the composite.

### FIELD OF THE INVENTION

The present invention relates to composite polymeric structures and more particularly to such a structure comprising a silicone polymer matrix having a layer of fabric encapsulated therein.

### BACKGROUND OF THE INVENTION

The fabricating capabilities of silicone polymers or rubbers are well known. The ready moldability of these materials makes them useful for the fabrication of a wide variety of products ranging from kitchen work gloves and to cell phone and electronics remote control key pads. The relatively high temperature resistance (on the order of +200° C.) and the relatively good heat insulation capabilities of these materials has also made them useful in applications such as hot dish holders or trivets for use in, for example, the home kitchen.

Applications such as those just described, especially those for use in the home kitchen are very sensitive to decorative features such as color and design in addition to the functional characteristics that make such items useful. Accordingly, although molded silicone can be pigmented or dyed to a wide variety of colors and even marble imitation modifications, it lacks the design flexibility provided by, for example, fabrics that can be woven into a virtually infinite number of designs.

It would thus be useful to have silicone structures that are relatively easy to fabricate and provide the heat resistance and thermal insulation properties of the parent silicone materials that can simultaneously provide the design variation advantages of fabrics.

### OBJECT OF THE INVENTION

It is therefore an object of the present invention to provide a silicone/fabric composite structure that provides the functional insulating and heat resistance advantages of moldable silicone materials while simultaneously providing the decorative/esthetic benefits of fabrics.

### SUMMARY OF THE INVENTION

According to the present invention, there is provided a composite structure comprising a woven fabric layer encapsulated in a silicone polymer or silicone rubber matrix. The woven fabric layer preferably comprises a woven fabric that includes apertures through which silicone polymer may penetrate during fabrication to provide complete or virtually complete encapsulation. Because of the method of fabrication, the woven fabric layer resides closer to one surface of the composite structure so that its esthetic design can best be seen from at least one surface of the composite structure. Relatively heat resistant fabrics such as cotton or Nomex® or Nomex® blend fabrics that provided even further enhanced heat resistance, are specifically preferred as the fabric portion. The incorporation of ceramic particles into the silicone polymer matrix enhances the thermal insulation properties of the composite.

### DESCRIPTION OF THE DRAWINGS

FIG. 1 is a cross-sectional view of the composite structure of the present invention.

FIG. 2 is a greatly enlarged cross-sectional view of the fabrication of the composite structure of the present invention.

FIG. 3 is a cross-section of an alternative fibrous structure for the woven fabric used in accordance with one preferred embodiment of the present invention.

FIG. 4 is a cross-sectional view of an alternative embodiment of the composite structure of the present invention.

### DETAILED DESCRIPTION

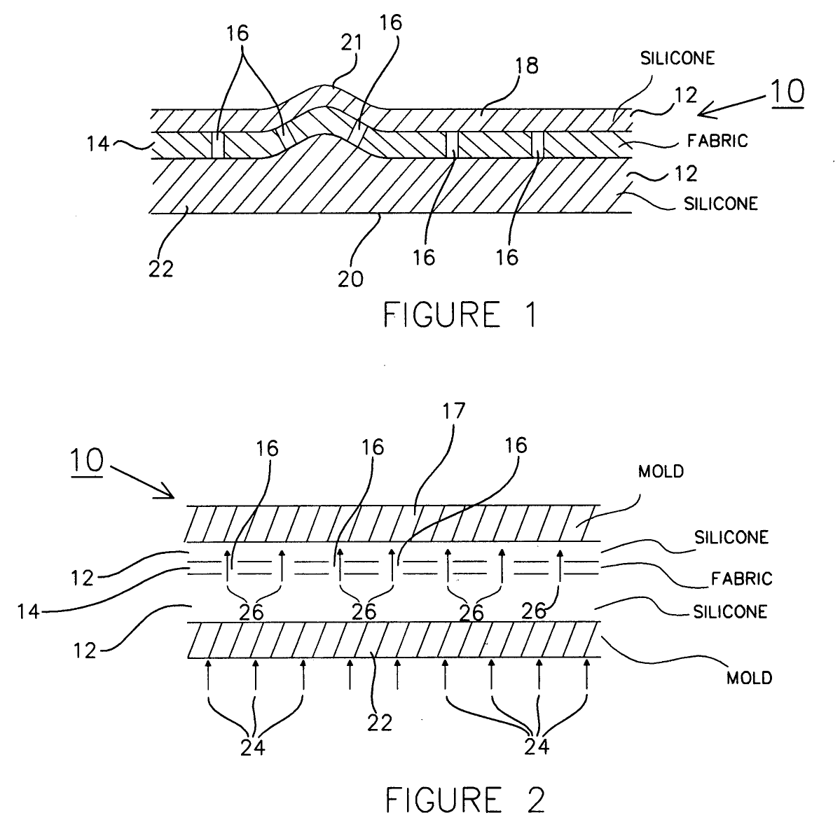

Referring now to FIG. 1, the layered composite structure 10 of the present invention comprises a silicone polymer matrix 12 encapsulating a woven fabric layer 14. As used herein, the term “encapsulated” is meant to define a state wherein the “porous” or apertured woven fabric is completely or virtually completely encased in or surrounded by the silicone matrix material, including through the penetration of silicone matrix material through the pores thereof as described hereinafter. As will be demonstrated, described and depicted in subsequent discussion, and schematically shown in FIGS. 1 and 2, silicone polymer 12 penetrates or permeates woven fabric layer 14 through apertures 16 (shown schematically in FIG. 1) therein to provide total or virtually total encapsulation of woven fabric layer 14 in silicone polymer 12. For reasons that will be described more fully below, it should be noted that woven fabric layer 14 is closer to surface 18 of composite 10 than it is to surface 20 thereof. Because of the relative translucence of silicone polymer 12, any pattern that is woven into woven fabric 14 is visible from the outside of composite 10 by someone viewing composite 10 from a position proximate surface 18. Thus, the esthetics of any pattern in woven fabric 14 are imparted to composite 10 as it is viewed by a user or viewer.

As shown in FIG. 2, the composite 10 of the present invention is fabricated by the placement of woven fabric 14 in a mold 19 comprising two opposing portions 17 and 22. Silicone polymer 12, in its “gummy” state at this point, is also placed in mold 19. Woven fabric 14 is preferably located closer to one of mold portions 17 or 22, in the representation depicted in FIG. 2, closer to mold portion 17. As pressure, as indicated by arrows 24, is applied in the conventional compression or injection molding process, woven fabric 14 is pushed toward mold portion 17 through the hydrostatic pressure on silicone polymer 12, and silicone polymer 12 is simultaneously forced through apertures 16 in woven fabric 14, as indicated by arrows 26, forming a relatively thin layer of silicone 12 between woven fabric 14 and mold portion 17. In this fashion, woven fabric 14 is encapsulated in silicone polymer 12 and forced toward, but not to or through, one surface of the final product.

While relatively heat resistant materials such as cotton, Kevlar® and Nomex® that can withstand relatively high temperatures are preferred for the composition of woven fabric 14, particularly in applications where composite 10 will be exposed to elevated temperatures, i.e. oven gloves, trivets or the like, other woven materials can be encapsulated as described herein, if temperature resistance is not an issue in the final product. Thus, any woven fabric that will allow for penetration of silicone polymer 12 as shown in FIG. 2 and will impart an esthetically pleasing design to the composite product 10 may be incorporated into composite 10.

As is apparent from a study of FIGS. 1 and 4, in order to achieve the esthetic benefits of the incorporated woven fabric, the woven fabric is preferably generally coplanar or more specifically is oriented parallel with the major plane of the silicone matrix of the article being fabricated. Ribs 21 or other surface features may be incorporated into the article surface or shape to enhance the thermal insulation or other properties of the composite 10. It will also be apparent that in order for the fabric to provide the esthetic advantages described herein, that the silicone matrix be at least translucent so that the woven fabric can be seen from the exterior of the composite. The silicone matrix may be dyed or pigmented to provide a dominant color to the article so long as translucency is maintained.

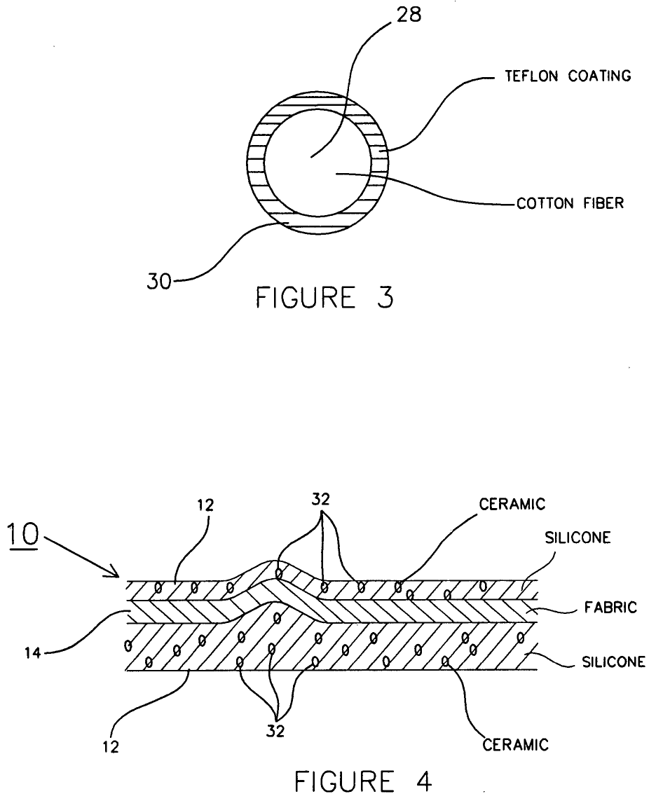

Even in the case of cotton, over long term exposure to elevated temperatures, the cotton may tend to darken due to charring thereof. Such charring is largely due to the oxidation of the cotton due to the presence of oxygen in or permeating, silicone polymer 12. In order to delay or inhibit such charring, the useful esthetic life of encapsulated woven cotton fabric 14 or any similar material may be extended through the use of fibers as depicted in FIG. 3. As shown in this Figure, the individual fibers 28 that comprise woven fabric 14 are encapsulated in a protective layer of a relatively less oxygen impermeable material such as Teflon® 30 or some other material. The presence of such a layer 30 reduces the exposure of fiber 28, cotton or another material, to oxygen thereby extending the useful esthetic life of composite 10 upon prolonged exposure to elevated temperatures. As will be apparent to the skilled artisan, a layer 30 of other fiber protective materials can also be used in the successful practice of the present invention.

Referring now to FIG. 4, in certain high temperature applications it may be that the thermal insulating properties of the silicone polymer may not be adequate to provide the degree of thermal insulation desired. This might be the case in, for example when the composite 10 was used in the fabrication of oven gloves or the like. In such situations, in order to enhance the thermal insulating properties of the composite, a highly thermal insulating ceramic particulate 32 such as aluminum oxide particulate can be dispersed in the gummy silicone polymer prior to forming the glove by molding. Such dispersion can be achieved using well-known techniques such as roller blending or the like. The ceramic/silicone molding compositions in such cases may comprise from about 10 to about 90 volume percent silicone and from about 90 to about 10 percent by volume of ceramic particulate. Preferably the ceramic particulate is of a particle size below about 10 mesh, but any suitable particle size that allows penetration of the compounded/blended silicone/ceramic molding composition through apertures 16, can be used. While aluminum oxide is a preferred ceramic any other useful thermally insulating ceramic such as aluminum carbide, aluminum nitride or the like could also be similarly dispersed in silicon 12 and composite 10 fabricated therefrom.

A particularly preferred class of silicone polymers for use in the present invention are those supplied under the trademark Winthane™Silicone elastomers that are available from Winfield Industries, 852 Kensington Ave., Buffalo, New York 14215 as liquids or gums that, when fabricated, retain their physical properties over a very wide range of working temperatures, minus 60° C.-+230° C.

There has thus been described a composite comprising a silicone matrix encapsulating a woven fabric for imparting the esthetic properties of the woven fabric to the molded silicone product by virtue of the proximity of the woven fabric to one at least one surface of the composite. The use of fabrics woven from fibers that are coated with a relatively more oxygen impermeable layer enhances the useful esthetic life of such products that are exposed to elevated temperatures and the incorporation of ceramic particles into the silicone matrix increases the thermal resistance or insulating properties of the composite product.

As the invention has been described, it will be apparent to those skilled in the art that the same may be varied in many ways without departing from the intended spirit and scope of the invention, and any and all such modifications are intended to be included within the scope of the appended claims.

1) a decorative composite comprising:
a) an at least partially transparent planar silicone polymer matrix having opposing planar surfaces and a major plane parallel to said opposing planar surfaces; and
b) a decorative fabric encapsulated in said silicone polymer matrix proximate one of said opposing surfaces parallel to said major plane and including apertures penetrated by said silicone polymer matrix such that said decorative fabric can be seen through the silicone polymer matrix from that opposing surface proximate said decorative fabric.

2) The decorative composite of claim 1 wherein said fabric comprises a fabric selected from the group consisting of woven cotton fabric, woven aramid fiber fabric.

3) The decorative composite of claim 1 wherein said silicone polymer matrix includes a ceramic dispersed therein.

4) The decorative composite of claim 2 wherein said silicone polymer matrix includes a ceramic dispersed therein.

5) The decorative composite of claim 3 wherein said ceramic comprises aluminum oxide.

6) The decorative composite of claim 4 wherein said ceramic comprises aluminum oxide.

7) The decorative composite of claim 1 wherein said fabric comprises a woven fabric formed by weaving individual fibers encapsulated in a peripheral relatively oxygen impermeable barrier layer.

8) The decorative composite of claim 7 wherein said silicone polymer matrix includes a ceramic dispersed therein.

9) The decorative composite of claim 8 wherein said ceramic comprises aluminum oxide.

10) A decorative composite comprising:
a) an at least partially transparent planar silicone polymer matrix having opposing planar surfaces and a major plane parallel to said opposing planar surfaces; and
b) a decorative woven fabric encapsulated in said silicone polymer matrix proximate one of said opposing surfaces parallel to said major plane and including apertures penetrated by said silicone polymer matrix fabricated by a process comprising:
i) placing said decorative woven fabric into a mold having a pair of opposing mold surfaces proximate one of said opposing mold surfaces;
ii) introducing a gummy silicone polymer material into the mold; and
iii) forming the silicone polymer composite by injection molding or compression molding whereby said decorative woven fabric is forced toward one of said opposing mold surfaces and said gummy silicone polymer is forced through said apertures in said decorative woven fabric thereby allowing said decorative fabric to be seen through the silicone polymer matrix from that opposing surface proximate said decorative woven fabric.

11) The decorative composite of claim 10 wherein said woven fabric comprises a fabric selected from the group consisting of woven cotton fabric and woven aramid fiber fabric.

12) The decorative composite of claim 10 wherein said silicone polymer matrix includes a ceramic dispersed therein.

13) The decorative composite of claim 11 wherein said silicone polymer matrix includes a ceramic dispersed therein.

14) The decorative composite of claim 12 wherein said ceramic comprises aluminum oxide.

15) The decorative composite of claim 13 wherein said ceramic comprises aluminum oxide.
